(19) United States
(12) Patent Application Publication
(10) Pub. No.: US 2026/0204879 A1
(43) Pub. Date: Jul. 16, 2026

(54) PANEL BOARD

(71) Applicant: LS ELECTRIC CO., LTD., Anyang-si (KR)

(72) Inventor: Seogang RYU, Anyang-si (KR)

(21) Appl. No.: 19/442,324

(22) Filed: Jan. 7, 2026

(30) Foreign Application Priority Data
Jan. 14, 2025 (KR) 10-2025-0005381

(51) Int. Cl. H02B 1/04; H02B 1/20

(52) U.S. Cl. CPC H02B 1/04; H02B 1/207

(57) ABSTRACT

A panel board is disclosed. According to an aspect of the present disclosure, the panel board may include a main busbar, a branch busbar, a first branch circuit breaker, and a second branch circuit breaker, and may include a disengagement-preventing assembly configured to restrict movement of the first branch circuit breaker and the second branch circuit breaker in a direction in which the first and second branch circuit breakers are disengaged from the branch busbar.

### CROSS-REFERENCE TO RELATED APPLICATION

The present application claims priority under 35 U.S.C. § 119(a) to Korean patent application number 10-2025-0005381 filed on January 14, 2025, in the Korean Intellectual Property Office, the entire disclosure of which is incorporated by reference herein.

### FIELD

The present disclosure relates to a panel board, and more particularly, to a panel board including a disengagement-preventing assembly.

### BACKGROUND

Electric power supplied through a power system is ultimately distributed to individual consumers through a panel board.

Such a panel board may include a case, a plurality of circuit breakers accommodated and installed inside the case, and a plurality of busbars or cables (hereinafter collectively referred to as “busbars”) for distributing power through the circuit breakers.

For example, referring to FIGS. 1 to 3, a low-voltage panelboard includes, inside a case 10, a plurality of main busbars 30 extending in one direction to supply power, a main circuit breaker 20 electrically connected to the main busbars 30, and a plurality of branch circuit breakers 50 electrically connected to the main busbars 30 via a plurality of branch busbars 40, such that supply and interruption of power are performed through these components.

The main busbars 30 and the branch busbars 40 form branch circuits for distributing power, and branch circuit breakers, such as miniature circuit breakers (MCBs) 50, are installed to control opening and closing of the branch circuits.

In general, a branch circuit breaker 50 is mounted on both sides with respect to one slot of a branch busbar 40. In the illustrated example, one branch circuit breaker is illustrated on each side; however, the branch circuit breakers 50 may be divided into a plurality of first branch circuit breakers 50a coupled and arranged on a left side in the drawing with the branch busbar 40 therebetween, and a plurality of second branch circuit breakers 50b coupled and arranged on a right side in the drawing, the first and second branch circuit breakers being arranged in a vertical direction.

Meanwhile, in most panel boards used in industrial sites, situations may arise in which the main circuit breaker 20 and branch circuit breakers 50 need to be replaced, separated, or rearranged for various reasons, such as changes in power capacity of branch wiring.

In addition, to minimize power outages in a power distribution system, inspection and replacement of branch circuit breakers may be required while the main busbars remain energized during troubleshooting and maintenance of branch circuits.

At this time, in order to minimize branch-circuit outages and improve convenience for a worker, branch circuit breakers 50 are typically implemented plug-on type miniature circuit breakers (MCBs) 50, so as to be easily coupled to or separated from the main busbars 30 while the main busbars 30 remain energized.

Such plug-on type branch circuit breakers 50 include, on one side thereof, a branch terminal 53 having a clip shape as a contact, and have a fixing structure in which the branch terminal 53 is opened by an external force applied when the branch circuit breaker 50 is pressed, and is then fitted onto and coupled to the branch busbar 40 in a direction perpendicular thereto.

However, such a coupling method that relies on clip elasticity of the branch terminal 53 inevitably entails a possibility that the branch circuit breaker 50 may become disengaged when elasticity of the branch terminal is reduced or when electrical and physical shocks and vibrations are applied.

If the branch circuit breaker 50 is disengaged while in an ON state, that is, while a branch circuit remains energized, a secondary electrical accident may occur due to generation of an arc produced momentarily.

To prevent this, a structure has been disclosed in which a protruding branch coupling portion 62a of a frame 60 is inserted into and supported by a coupling groove S1 formed on the other side of a branch circuit breaker 50; however, the branch circuit breaker 50 is still not stably fixed and tends to wobble, thereby causing problems such as disengagement from the branch busbar 40.

Accordingly, there is a need to develop a panel board in which a branch circuit breaker 50 can be stably fixed even under physical shocks or vibrations, so that the branch circuit breaker 50 is prevented from being arbitrarily disengaged.

Meanwhile, in a conventional panel board, an open space A in which an energized portion of the branch busbar 40 is exposed is inevitably formed due to a gap D1 between a first branch circuit breaker 50a and a second branch circuit breaker 50b.

As a result, during inspection of the panel board, there has always been a risk of electric shock accidents to a human body, such as cases in which a worker may inadvertently come into contact with the energized portion.

Accordingly, there is also a need to develop a panel board capable of blocking the open space A in which an energized portion of the branch busbar 40 is exposed, thereby enhancing safety.

### SUMMARY

The present disclosure has been made to address the above-described problems, and an object of the present disclosure is to provide a panel board capable of stably fixing a branch circuit breaker, thereby preventing arbitrary disengagement of the branch circuit breaker even under external physical shocks or vibrations.

Another object of the present disclosure is to provide a panel board capable of blocking an open space in which an energized portion of a branch busbar is exposed, thereby preventing unauthorized contact by a worker, reducing a risk of electric shock, and ensuring safety.

The technical problems addressed by this disclosure are not limited to the foregoing, and other technical problems not mentioned will be readily understood by one of ordinary skill in the art from the following description.

According to an aspect of this disclosure, a panel board is disclosed.

A panel board may include a main busbar; a branch busbar electrically connected to the main busbar; a first branch circuit breaker electrically connected to and coupled to one side of the branch busbar; a second branch circuit breaker electrically connected to and coupled to the other side of the branch busbar while being physically spaced apart from the first branch circuit breaker to form an open space in which the branch busbar is exposed to the outside; and a disengagement-preventing assembly detachably coupled to the branch busbar through the open space and configured to restrict movement of the first branch circuit breaker and the second branch circuit breaker in a direction in which the first and second branch circuit breakers are disengaged and moved away from the branch busbar.

In this case, the branch busbar may include a fixing hole formed in an energized portion of the branch busbar exposed to the open space. In this case, the disengagement-preventing assembly may be detachably coupled to the fixing hole.

In this case, the disengagement-preventing assembly may include a restraining wing extending laterally to cover at least a portion of the first branch circuit breaker and the second branch circuit breaker.

In this case, the restraining wing may be formed to have an adjustable length.

In this case, the disengagement-preventing assembly may cover an energized portion of the branch busbar that is exposed to the outside in the open space so as to block exposure of the branch busbar.

Meanwhile, the disengagement-preventing assembly may include an adapter detachably coupled to the branch busbar in the open space; and a restraining block coupled to the adapter and having a restraining wing formed to extend laterally so as to cover at least a portion of the first branch circuit breaker and the second branch circuit breaker.

In this case, the branch busbar may form a fixing hole in an energized portion exposed to the open space. The adapter may include an adapter body having a fixing hook protruding to be inserted into the fixing hole; and a fastening-member groove in which a fastening member is coupled.

In this case, the adapter body may further include an insertion protrusion extending with a length toward the restraining block side.

In this case, the adapter body may further include an insert tab inserted into and coupled to an insert groove of the adapter body, the insert tab having a through-hole forming the fastening-member groove.

In this case, the restraining block may include a block body inserted into the open space and having a hollow fastening-member hole formed therein through which a fastening member passes; a first restraining wing extending from one end of the block body to cover at least a portion of the first branch circuit breaker; and a second restraining wing extending from the other end of the block body to cover at least a portion of the second branch circuit breaker.

In this case, the block body may further include a position-fixing groove into which an insertion protrusion extending with a length from the adapter is inserted.

According to the above-described configuration, the panel board according to the present disclosure has an effect in that restraining wings of the disengagement-preventing assembly, which extend toward the branch circuit breaker, block movement of the branch circuit breaker in a direction in which the branch circuit breaker is disengaged from the branch busbar and fix a position of the branch circuit breaker, thereby preventing arbitrary disengagement of the branch circuit breaker even when electrical and physical shocks and vibrations occur and elasticity of a branch terminal is reduced.

In addition, the disengagement-preventing assembly has a structure in which the disengagement-preventing assembly is coupled to the branch busbar while filling an open space formed by a gap between the first branch circuit breaker and the second branch circuit breaker, thereby blocking external exposure of the branch busbar and preventing safety accidents.

In addition, the disengagement-preventing assembly has a structure including an adapter hook-coupled to the branch busbar and a restraining block coupled to the adapter via a fastening member, thereby increasing fixing force while facilitating disassembly and assembly and enhancing ease of use.

It should be understood that the effects of this disclosure are not limited to those described above, and include all effects that can be inferred from the configurations of the disclosure described in the detailed description or in the claims.

### BRIEF DESCRIPTION OF THE DRAWINGS

FIG. 1 is a schematic view illustrating a panel board according to the related art.

FIG. 2 is a view for explaining that a first branch circuit breaker and a second branch circuit breaker are coupled to a branch busbar in a panel board according to the related art.

FIG. 3 is a view illustrating a state in which a first branch circuit breaker and a second branch circuit breaker are coupled to a branch busbar in a panel board according to the related art, and is for explaining that an open space in which the branch busbar is exposed is formed by a gap between the first branch circuit breaker and the second branch circuit breaker.

FIG. 4 is a schematic view illustrating a panel board according to an embodiment of the present disclosure.

FIG. 5 is an enlarged schematic view illustrating a disengagement-preventing assembly applied to a panel board according to an embodiment of the present disclosure.

FIG. 6 is a view illustrating an example of a branch busbar and a disengagement-preventing assembly applied to a panel board according to an embodiment of the present disclosure.

FIG. 7 is a view illustrating an example of an adapter constituting a disengagement-preventing assembly applied to a panel board according to an embodiment of the present disclosure.

FIG. 8 is an exploded perspective view illustrating a configuration of the adapter of FIG. 7.

FIGS. 9 and 10 are views illustrating an example of a restraining block constituting a disengagement-preventing assembly applied to a panel board according to an embodiment of the present disclosure.

FIG. 11 is a schematic view illustrating an example in which an adapter and a restraining block constituting a disengagement-preventing assembly are disposed in a spaced open space between a first branch circuit breaker and a second branch circuit breaker in a panel board according to an embodiment of the present disclosure.

FIG. 12 is a schematic usage state view illustrating that exposure of a branch busbar is blocked by a disengagement-preventing assembly and movement of a first branch circuit breaker and a second branch circuit breaker is restrained in a panel board according to an embodiment of the present disclosure.

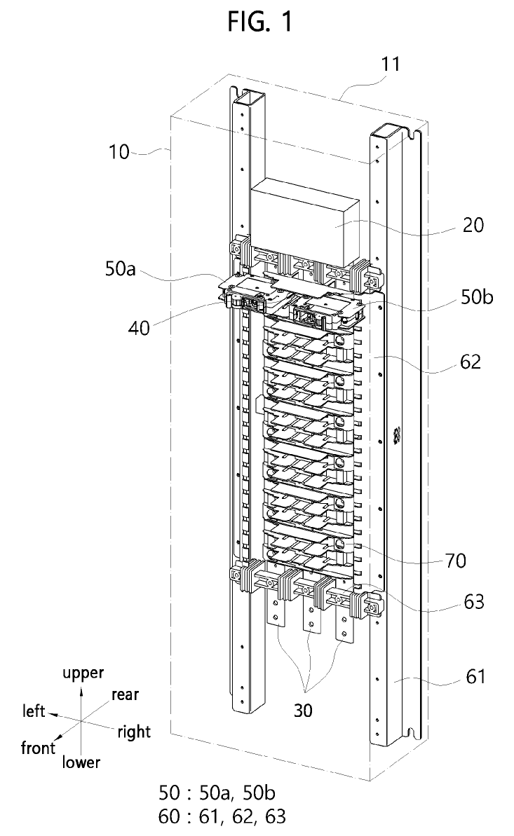

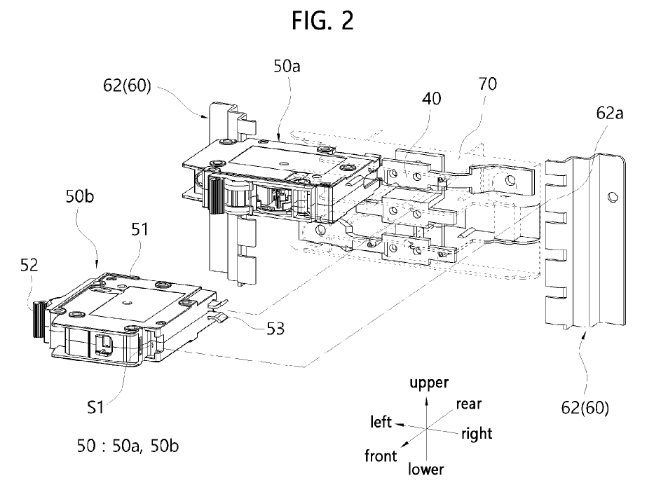

### DETAILED DESCRIPTION

Hereinafter, embodiments of the present disclosure will be described in detail with reference to the accompanying drawings so that those of ordinary skill in the art can readily implement the present disclosure. The present disclosure may be embodied in various different forms and is not limited to the embodiments described herein. In order to clearly describe the present disclosure, portions unrelated to the description are omitted from the drawings, and the same or similar elements are denoted by the same reference numerals throughout the specification.

In this specification, the terms “include” and “have” are intended to describe the presence of features, numbers, steps, operations, elements, components, or combinations thereof as set forth in the specification, and are not to be understood as excluding the presence or addition of one or more other features, numbers, steps, operations, elements, components, or combinations thereof.

Unless otherwise specified, a component being located at a “front,” “rear,” “upper,” or “lower” side of another component includes not only being positioned immediately adjacent to the other component at the front, rear, upper, or lower side, but also being positioned with one or more other components disposed therebetween. In addition, unless otherwise specified, a component being “connected” to another component includes both direct connection and indirect connection.

In addition, positional terms such as “upper,” “lower,” “left,” and “right” used in the description are to be understood with reference to the coordinate system illustrated in the drawings. Such terms are merely examples based on a relative perspective and do not limit absolute positions of the respective components.

In describing the present disclosure, detailed descriptions of related well-known functions or configurations are omitted so as not to obscure the gist of the present disclosure.

Hereinafter, a panel board according to an embodiment of the present disclosure will be described with reference to the accompanying drawings.

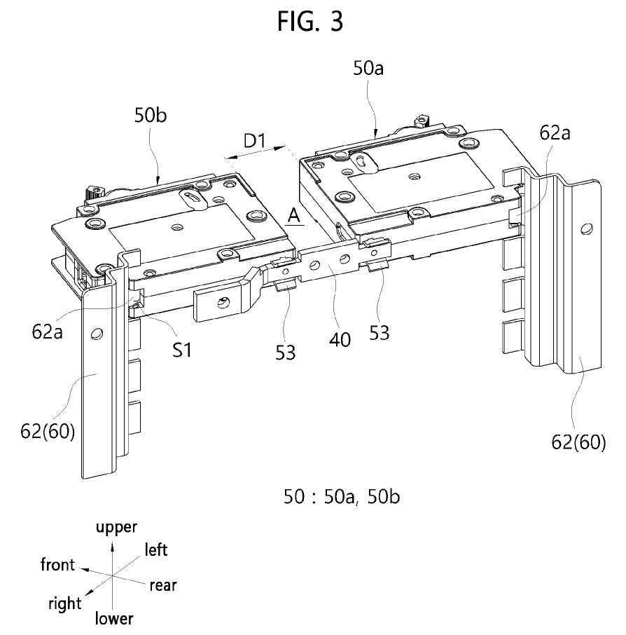

As illustrated, a panel board 1 according to an embodiment of the present disclosure is configured not only to stably fix a branch circuit breaker 50 so as to prevent unintended disengagement of the branch circuit breaker 50 even when external physical impact or vibration occurs, but also to block an open space A in which an energized portion of a branch busbar 40 is exposed due to a gap D1 (FIG. 3) between a first branch circuit breaker 50a and a second branch circuit breaker 50b, thereby preventing inadvertent contact of a worker with the branch busbar 40 and reducing an electric shock risk to improve safety.

To this end, a panel board 1 according to an embodiment of the present disclosure is characterized in that the panel board 1 includes a disengagement-preventing assembly 100 that restricts movement of branch circuit breakers 50, 50a, and 50b in a direction in which the branch circuit breakers 50, 50a, and 50b are disengaged and moved away from a branch busbar 40, that is, in a forward direction, through an open space A formed by a gap D1 between a first branch circuit breaker 50a and a second branch circuit breaker 50b.

Preferably, the disengagement-preventing assembly 100 may be formed of an insulating material.

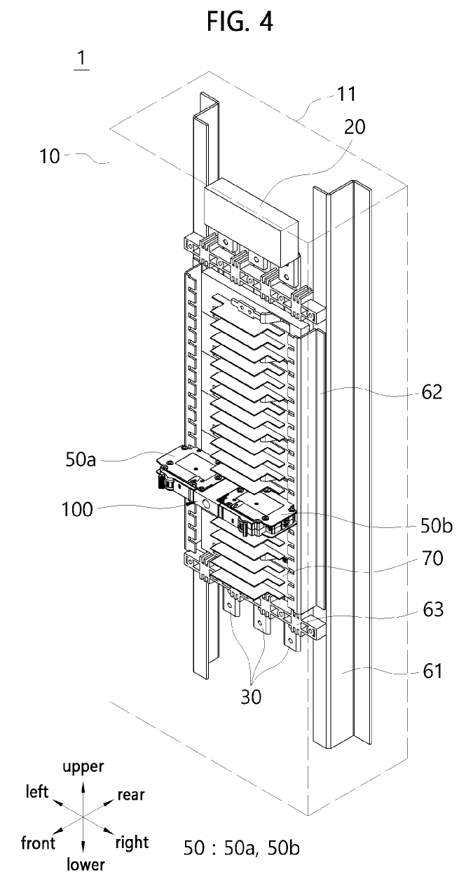

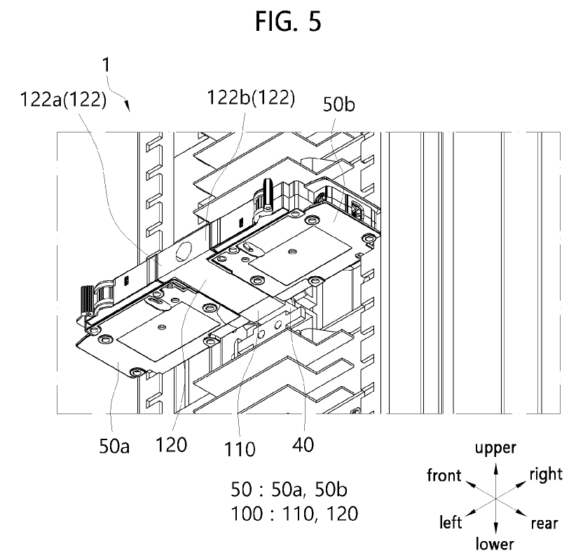

More specifically, referring again to FIG. 3 together with FIGS. 4 and 5, a panel board 1 according to an embodiment of the present disclosure may include, inside a case 10 including a base plate 11, a main circuit breaker 20 and a main busbar 30, a plurality of branch busbars 40 electrically connected to the main busbar 30, and a plurality of branch circuit breakers 50, 50a, and 50b mounted on respective branch busbars 40.

In this case, the branch circuit breaker 50 may be divided into a first branch circuit breaker 50a and a second branch circuit breaker 50b, and the panel board may include a disengagement-preventing assembly 100 coupled to the branch busbar 40 through an open space A formed between the first branch circuit breaker 50a and the second branch circuit breaker 50b.

First, the case 10 forms an exterior of the panel board 1 and may be in the form of a housing an internal space. For example, as illustrated, the case 10 may have a rectangular housing shape; however, the shape of the case 10 is not limited thereto and may have various modified shapes.

The case 10 includes a flat base plate 11 to facilitate installation of circuit breakers and the like, and the above-described main circuit breaker 20 and main busbar 30, as well as branch circuit breakers 50 and branch busbars 40, may be accommodated and arranged on a front surface of the base plate 11. The case 10 may be grounded.

Meanwhile, the main circuit breaker 20 is configured to cut off or connect external power and may be disposed inside the case 10 on a front side of the base plate 11.

The main circuit breaker 20 has a structure in which a terminal thereof is electrically connected to the main busbar 30. The main circuit breaker 20 may employ a known structure and configuration, and a detailed description thereof will be omitted so as not to obscure the gist of the present disclosure.

Meanwhile, the main busbar 30 may be, for example, a three-phase main busbar, may have a bar shape of a rail extending in a lengthwise direction from an upper side toward a lower side, and may be disposed on the front surface of the base plate 11 while being electrically connected to the main circuit breaker 20.

That is, the main busbars 30 may have a bar shape extending in an up-and-down direction, and a plurality of the main busbars 30 may be arranged on the front surface of the base plate 11 to be spaced apart from each other in a left-and-right direction, as illustrated in FIG. 4.

In addition, the branch busbars 40 may have a bar shape extending in the left-and-right direction, and a plurality of the branch busbars 40 may be arranged on the front surface of the main busbar 30 to be spaced apart from each other in the up-and-down direction while being electrically connected to the main busbar 30.

Preferably, the branch busbar 40 is electrically connected to one of the plurality of main busbars 30, and accordingly, the branch circuit breaker 50 may also be electrically connected to one of the main busbars 30 through the branch busbar 40.

The main busbar 30 and the branch busbar 40 form a branch circuit that branches electric power, and a branch circuit breaker 50, such as a miniature circuit breaker (MCB), is installed to control opening and closing of the branch circuit.

Meanwhile, the branch circuit breaker 50 is configured to receive electric power distributed from the main circuit breaker 20 and is configured to interrupt the distributed electric power or supply the distributed electric power to a power consumer.

The branch circuit breakers 50 may be arranged in a plurality in succession below the main circuit breaker 20 and may have a structure in which the branch circuit breakers 50 are electrically connected to the main busbar 30 through the branch busbar 40.

The branch circuit breaker 50 may have a structure in which branch circuit breakers 50 are attached to both sides with respect to one slot of the branch busbar 40, and the branch circuit breakers 50 may be divided into a plurality of first branch circuit breakers 50a coupled and arranged on a left side in the illustrated example and a plurality of second branch circuit breakers 50b coupled and arranged on a right side with the branch busbar 40 interposed therebetween.

That is, the first branch circuit breaker 50a may be electrically connected to and coupled to one side of the branch busbar 40, that is, the left side in the illustrated example.

In addition, the second branch circuit breaker 50b may be electrically connected to and coupled to the other side of the branch busbar 40 opposite to the first branch circuit breaker 50a, that is, the right side in the illustrated example.

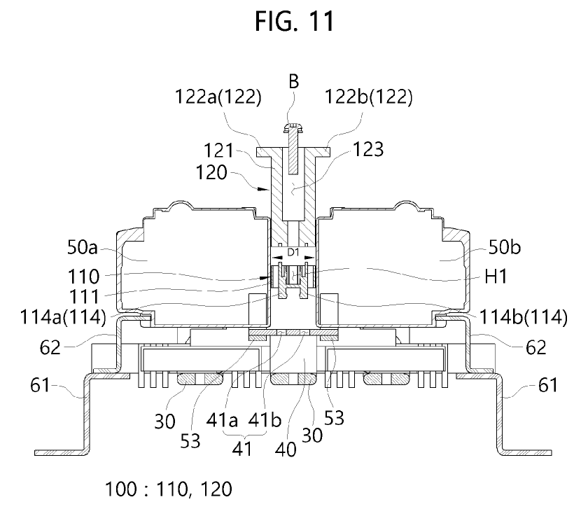

At this time, the second branch circuit breaker 50b is disposed to be physically spaced apart from the first branch circuit breaker 50a, and, in the illustrated example, the second branch circuit breaker 50b is spaced apart from the first branch circuit breaker 50a in the left-and-right direction with the gap D1 as illustrated in FIG. 11, thereby forming the open space A between the first branch circuit breaker 50a and the second branch circuit breaker 50b in which the branch busbar 40 is exposed to the outside, as illustrated in FIG. 3.

Meanwhile, the panel board 1 according to an embodiment of the present disclosure illustrates, as an example, use of a plug-on type branch circuit breaker 50, such as a miniature circuit breaker MCB, which is coupled to the branch busbar 40 through a branch terminal 53, so that the branch circuit breaker 50 can be easily attached or detached in an energized state of the main busbar 30 to minimize branch-circuit power interruption and improve convenience for a worker.

However, the present disclosure is not limited to the plug-on type branch circuit breaker 50, and as long as the branch circuit breakers 50 are arranged in the form of a first branch circuit breaker 50a and a second branch circuit breaker 50b with a physical gap D1 therebetween, various types of branch circuit breakers, such as a bolt-fastened type, may of course be applied.

Meanwhile, the above-described main circuit breaker 20, main busbar 30, branch circuit breaker 50, and branch busbar 40 may be arranged to have a structure in which they are supported by a frame 60 inside the case 10 of the panel board 1.

Preferably, the frame 60 has a structure in which the frame 60 is fixedly coupled to the front surface of the base plate 11 through a fastening member such as a bolt, and may have a bar shape extending in the up-and-down direction and be disposed on the front surface of the base plate 11 to be spaced apart from the above-described main busbar 30 and arranged in parallel on left and right sides of the main busbar 30.

The frame 60 may include a main frame 61, a fixed frame 62 in which a branch coupling portion 62a is formed, and a connection frame 63 supporting the main busbar 30, and since these configurations are well known in the art, a detailed description thereof will be omitted so as not to obscure the gist of the present disclosure.

In addition, electrical connection relationships among the main circuit breaker 20, the main busbar 30, the branch busbar 40, and the branch circuit breaker 50 are also well known in the art, and a detailed description thereof will be omitted so as not to obscure the gist of the present disclosure.

Hereinafter, the panel board 1 according to an embodiment of the present disclosure may include a disengagement-preventing assembly 100 configured to prevent unintended disengagement of the branch circuit breaker 50.

At this time, the disengagement-preventing assembly 100 may have a structure in which it is detachably coupled to an energized portion of the branch busbar 40 exposed through the open space A.

In addition, the disengagement-preventing assembly 100 may have a structure configured to restrict the first branch circuit breaker 50a and the second branch circuit breaker 50b from being disengaged and moved away from the branch busbar 40, that is, from moving forward in the drawing.

Preferably, the disengagement-preventing assembly 100 fills the open space A between the first branch circuit breaker 50a and the second branch circuit breaker 50b and is coupled to an energized portion of the branch busbar 40 at a gap D1. Depending on a shape characteristic of the branch circuit breakers 50, the disengagement-preventing assembly 100 may have a bar shape extending in a front-rear direction (see FIG. 5).

At this time, the disengagement-preventing assembly 100 may include a restraining wing 122 having a shape extending laterally from a longitudinal end thereof so as to cover at least a portion of a front-side end of each of the first branch circuit breaker 50a and the second branch circuit breaker 50b.

Such a restraining wing 122 may be divided into a first restraining wing 122a extending to cover at least a portion of the first branch circuit breaker 50a, and a second restraining wing 122b extending to cover at least a portion of the second branch circuit breaker 50b.

Referring to FIG. 5, in the illustrated example, the first restraining wing 122a and the second restraining wing 122b are illustrated as being integrally formed as a single plate shape extending laterally. However, the present disclosure is not limited thereto, and the first restraining wing 122a and the second restraining wing 122b may alternatively have a separable structure detachably coupled to the disengagement-preventing assembly 100, as necessary.

In addition, the first restraining wing 122a and the second restraining wing 122b may each have a configuration divided into a plurality of segments depending on shapes of the first branch circuit breaker 50a and the second branch circuit breaker 50b.

In other words, the first restraining wing 122a and the second restraining wing 122b may have various shapes, so long as they are arranged to extend laterally with a length from the disengagement-preventing assembly 100 and are capable of restricting forward movement of the first branch circuit breaker 50a or the second branch circuit breaker 50b in which the first or second branch circuit breaker is disengaged and moved away from the branch busbar 40.

In addition, the restraining wing 122, 122a, and 122b may have a shape whose length is adjustable so as to cover at least a portion of the first branch circuit breaker 50a and the second branch circuit breaker 50b in accordance with the gap D1 between the first branch circuit breaker 50a and the second branch circuit breaker 50b.

Such a length-adjustment structure of the restraining wing 122 may include a structure in which the length is adjusted in a sliding manner along an extending direction (leftward or rightward in the drawing), or a structure in which the length is adjusted by fixedly coupling a separate plate to an end portion of the restraining wing via a fastening member or the like.

Since various known techniques may be applied to such a length-adjustment structure of the restraining wing 122, a detailed description thereof will be omitted.

Meanwhile, the disengagement-preventing assembly 100 applied to the panel board 1 of the present disclosure may be detachably coupled to an energized portion of the branch busbar 40 exposed to the open space A.

To this end, the branch busbar 40 may include at least one fixing hole 41 in the energized portion exposed to the open space A.

In addition, the disengagement-preventing assembly 100 may be detachably coupled to the fixing hole 41 described above. To this end, the disengagement-preventing assembly 100 may include at least one fixing hook 114 formed to protrude rearward so as to be detachably coupled to the fixing hole 41.

In the illustrated example, the fixing hole 41 of the branch busbar 40 is formed as a first fixing hole 41a on a left side and a second fixing hole 41b on a right side, and the fixing hook 114 of the disengagement-preventing assembly 100 is formed as a first fixing hook 114a that passes through and is hook-fixed to the first fixing hole 41a, and a second fixing hook 114b that passes through and is hook-fixed to the second fixing hole 41b.

Referring to FIG. 5, the disengagement-preventing assembly 100 applied to the panel board 1 of the present disclosure is coupled to the branch busbar 40 while covering the energized portion of the branch busbar 40 exposed in the open space between the first branch circuit breaker 50a and the second branch circuit breaker 50b.

Through this, the disengagement-preventing assembly 100 blocks exposure of the energized portion of the branch busbar 40, thereby preventing unauthorized operators from arbitrarily contacting the branch busbar 40 and preventing safety accidents.

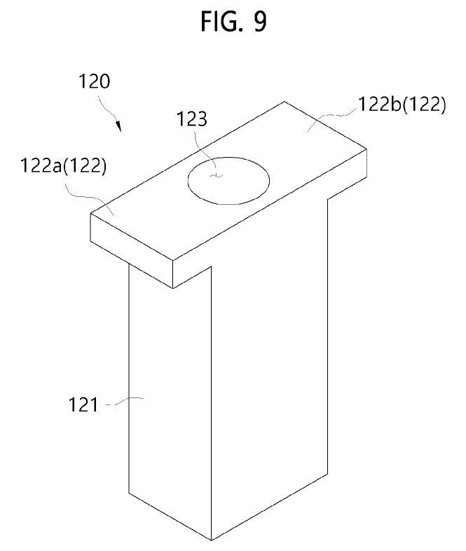

Meanwhile, with reference to FIG. 5 and FIGS. 6 to 10, the disengagement-preventing assembly 100 applied to the panel board 1 according to an embodiment of the present disclosure will be described in more detail as follows.

As described above, the disengagement-preventing assembly 100 applied to the panel board 1 according to an embodiment of the present disclosure is detachably coupled to the branch busbar 40 through the open space A, and is capable of restricting movement of the first branch circuit breaker 50a and the second branch circuit breaker 50b in a direction in which the first and second branch circuit breakers are disengaged and moved away from the branch busbar 40.

To this end, the disengagement-preventing assembly 100 may broadly include an adapter 110 and a restraining block 120.

As such, the disengagement-preventing assembly 100 applied to the panel board 1 of the present disclosure has a structure divided into the adapter 110 and the restraining block 120, thereby facilitating coupling, increasing fixing force, enhancing restraining force for the branch circuit breaker 50, and maximizing safety.

First, the adapter 110 is detachably coupled to the branch busbar 40 in the open space A, and may have a block shape capable of covering the energized portion of the branch busbar 40 exposed in the open space A.

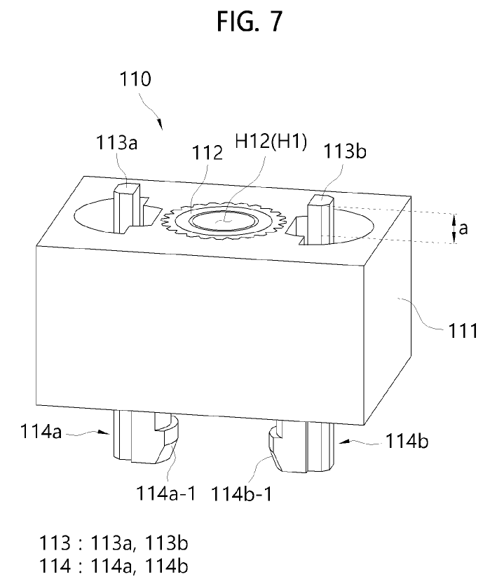

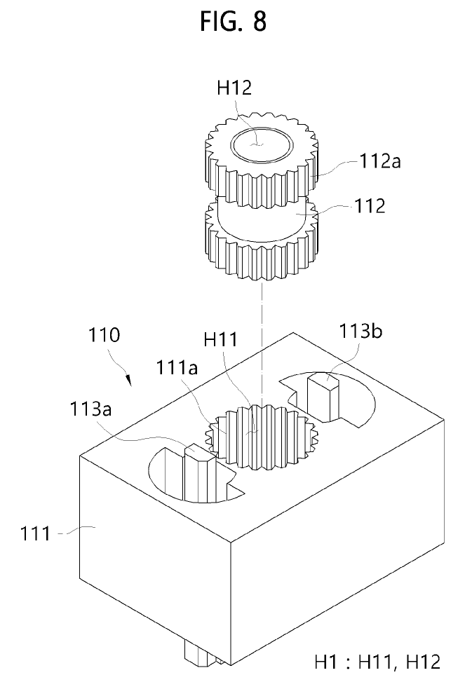

Referring to FIGS. 7 and 8, the adapter 110 may include a block-shaped adapter body 111.

At this time, the adapter body 111 may be formed with a fixing hook 114 protruding from one surface thereof (a rear surface in the drawing) so as to be inserted into the fixing hole 41 formed in the exposed energized portion of the branch busbar 40. In addition, the adapter body 111 may be formed with a fastening-member groove H1 in which a fastening member B, such as a bolt, is coupled on the other surface thereof (a front surface in the drawing) so as to be coupled to a restraining block 120 to be described later.

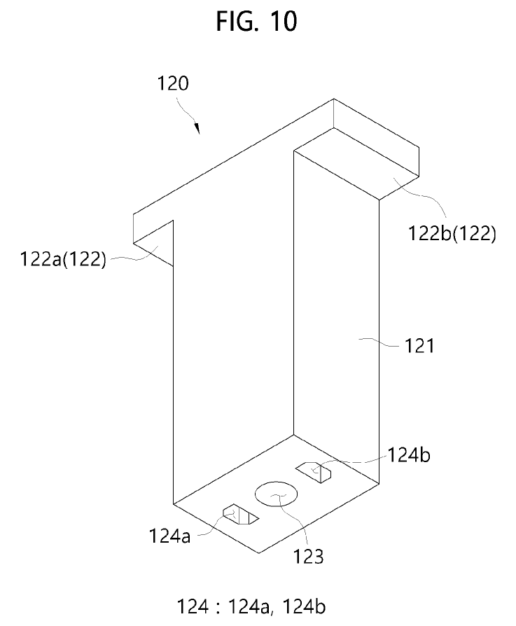

In addition, the adapter body 111 may include at least one insertion protrusion 113 that is adjacent to the fastening-member groove H1 on the other surface thereof (a front surface in the drawing) and protrudes toward the restraining block 120 with a length a (see FIG. 7) so as to be insertable into a position-fixing groove 124 (see FIG. 10) of the restraining block 120 to be described later.

In the illustrated example, the position-fixing groove 124 is formed as two grooves, namely, a first position-fixing groove 124a and a second position-fixing groove 124b, and the insertion protrusion 113 is formed as a first insertion protrusion 113a fitted into the first position-fixing groove 124a and a second insertion protrusion 113b fitted into the second position-fixing groove 124b. However, the present disclosure is not limited thereto, and the position-fixing grooves 124 and the insertion protrusions 113 may be formed in a plurality, as necessary.

Meanwhile, the adapter 110 may further include an insert tab 112 to facilitate coupling of the fastening member B.

At this time, the insert tab 112 may have a tubular shape in which a hollow through-hole H12 is formed so as to form the fastening-member groove H1.

In this case, the insert tab 112 may be formed of a material having rigidity sufficient to withstand an external force generated when the fastening member B is coupled.

At this time, the insert tab 112 may be inserted into and coupled to the insert groove H11 of the adapter body 111, and coupling protrusions 111a and 112a may be formed in complementary uneven shapes on an inner peripheral surface of the insert groove H11 and an outer peripheral surface of the insert tab 112, respectively, so as to mutually engage with each other.

In addition, the restraining block 120 of the disengagement-preventing assembly 100 is coupled to a front surface of the adapter 110 described above and may have a block shape extending in a front-rear direction.

Such a restraining block 120 may include a restraining wing 122 extending laterally so as to cover at least a portion of the first branch circuit breaker 50a and the second branch circuit breaker 50b from a front side. Accordingly, the restraining block 120 may have a T-shaped block form.

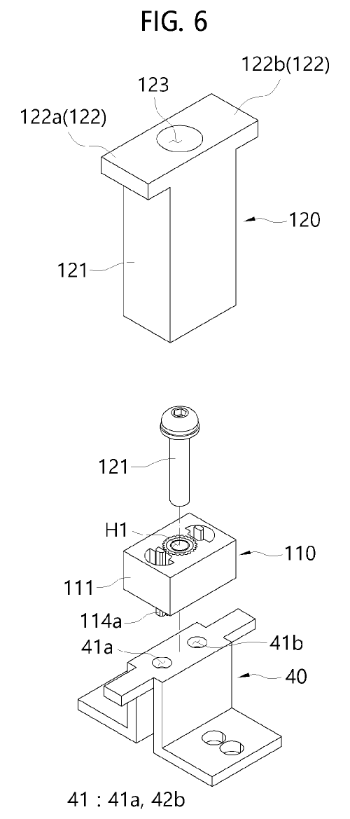

More specifically, referring to FIGS. 6, 9, and 10, the restraining block 120 constituting the disengagement-preventing assembly 100 may broadly include a block body 121, a first restraining wing 122a, and a second restraining wing 122b.

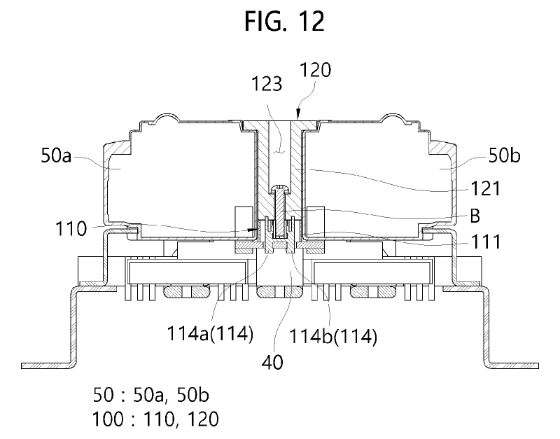

By way of example, the block body 121 may have a block form having a rectangular or polygonal column shape, and may be inserted into the open space A and integrally coupled to the front surface of the adapter 110 via a fastening member B (see FIGS. 11 and 12).

To this end, the block body 121 may be formed with a hollow fastening-member hole 123 through which the fastening member B passes. The fastening-member hole 123 may be positioned to correspond to the fastening-member groove H1 of the adapter 110, such that, when the adapter 110 and the restraining block 120 are coupled to each other, the fastening-member hole 123 and the fastening-member groove H1 are aligned to communicate with each other.

In addition, the first restraining wing 122a may be formed to extend from a front-side end in a longitudinal direction of the block body 121 so as to cover at least a portion of the first branch circuit breaker 50a.

In addition, the second restraining wing 122b may be formed to extend from the other front-side end in the longitudinal direction of the block body 121 so as to cover at least a portion of the second branch circuit breaker 50b.

As already described above, the first restraining wing 122a and the second restraining wing 122b may have various shapes.

Meanwhile, the block body 121 forms a position-fixing groove 124 into which the insertion protrusion 113, protruding from the adapter body 111 with a length, is inserted so as to facilitate coupling of the restraining block 120 to the adapter 110. The position-fixing groove 124 may be formed on a rear surface of the block body 121 that faces the front surface of the adapter 110.

Referring to FIGS. 11 and 12, a usage state of the disengagement-preventing assembly 100 in the panel board 1 according to an embodiment of the present disclosure will be described as follows.

As described above, in the panel board 1 according to an embodiment of the present disclosure, a plug-on type first branch circuit breaker 50a and a plug-on type second branch circuit breaker 50b have a structure in which they are coupled to left and right sides of the branch busbar 40 via branch terminals 53 with a gap D1 therebetween.

At this time, the disengagement-preventing assembly 100 has a structure in which it is detachably coupled to the branch busbar 40 through an open space A (see FIG. 3) formed by a gap D1, so as to prevent arbitrary disengagement of the branch circuit breakers 50 (50a, 50b).

At this time, the disengagement-preventing assembly 100 may be composed of an adapter 110 and a restraining block 120 having a restraining wing 122, and the adapter 110 may be fixed by hook engagement as the fixing hook 114 passes through the fixing hole 41 of the branch busbar 40.

At this time, the adapter 110 may have a size sufficient to cover the exposed energized portion of the branch busbar 40, thereby blocking exposure of the energized portion.

Such an adapter 110 may be coupled to the branch busbar 40 before the branch circuit breakers 50, 50a, and 50b are coupled, or, as necessary, may be coupled to the branch busbar 40 after the branch circuit breakers 50, 50a, and 50b are coupled.

In addition, the restraining block 120 may be inserted into the open space A (see FIG. 3) formed by a gap D1 and coupled to the adapter 110 via a fastening member B.

At this time, the fastening-member hole 123 of the restraining block 120 communicates with the fastening-member groove H1 of the adapter 110, and the fastening member B may be coupled to the insert tab 112 of the adapter 110.

Through the fastening member B, the adapter 110 and the restraining block 120 may be integrally coupled to each other (see FIG. 12).

Meanwhile, as the restraining block 120 of the disengagement-preventing assembly 100 is coupled to the adapter 110, the first restraining wing 122a among the restraining wings 122 partially covers a front-side end of the first branch circuit breaker 50a, thereby blocking the first branch circuit breaker 50a from being disengaged in a forward direction.

In addition, among the restraining wings 122, the second restraining wing 122b partially covers a front-side end of the second branch circuit breaker 50b, thereby blocking the second branch circuit breaker 50b from being disengaged in a forward direction.

As described above, in the panel board 1 according to an embodiment of the present disclosure, the restraining wings 122, 122a, and 122b extending from the disengagement-preventing assembly 100 toward the branch circuit breakers 50, 50a, and 50b block movement of the branch circuit breakers 50 in a direction in which the branch circuit breakers 50 are disengaged from the branch busbar 40, thereby fixing positions of the branch circuit breakers 50.

Accordingly, even when electrical and physical shocks and vibrations are applied to the branch circuit breaker 50, or when elasticity of the branch terminal 53 is reduced, arbitrary disengagement of the branch circuit breaker 50 can be prevented.

In addition, the disengagement-preventing assembly 100 has a structure in which it is coupled to the branch busbar 40 while filling the open space A formed by a gap D1 between the first branch circuit breaker 50a and the second branch circuit breaker 50b, thereby blocking external exposure of an energized portion of the branch busbar 40 and preventing safety accidents to a worker.

In addition, the disengagement-preventing assembly 100 has a structure including an adapter 110 hook-coupled to the branch busbar 40 and a restraining block 120 coupled to the adapter 110 via a fastening member B, thereby increasing fixing force while facilitating disassembly and assembly and enhancing ease of use.

Although embodiments of the present disclosure have been described, the spirit of the present disclosure is not limited to the embodiments set forth herein. Those of ordinary skill in the art who understand the spirit of the present disclosure will readily devise other embodiments within the same spirit by addition, modification, deletion, substitution, or combination of components, and such embodiments shall also fall within the scope of the present disclosure.

What is claimed is:

1. A panel board comprising:
a main busbar;
a branch busbar electrically connected to the main busbar;
a first branch circuit breaker electrically connected to and coupled to one side of the branch busbar;
a second branch circuit breaker electrically connected to and coupled to the other side of the branch busbar while being physically spaced apart from the first branch circuit breaker to form an open space in which the branch busbar is exposed to the outside; and
a disengagement-preventing assembly detachably coupled to the branch busbar through the open space and configured to restrict movement of the first branch circuit breaker and the second branch circuit breaker in a direction in which the first and second branch circuit breakers are disengaged and moved away from the branch busbar.

2. The panel board of claim 1, wherein the branch busbar includes a fixing hole formed in an energized portion of the branch busbar exposed to the open space, and
wherein the disengagement-preventing assembly is detachably coupled to the fixing hole.

3. The panel board of claim 1, wherein the disengagement-preventing assembly includes:
a restraining wing extending laterally to cover at least a portion of the first branch circuit breaker and the second branch circuit breaker.

4. The panel board of claim 3, wherein the restraining wing is formed to have an adjustable length.

5. The panel board of claim 1, wherein the disengagement-preventing assembly covers an energized portion of the branch busbar that is exposed to the outside in the open space so as to block exposure of the branch busbar.

6. The panel board of claim 1, wherein the disengagement-preventing assembly includes:
an adapter detachably coupled to the branch busbar in the open space; and
a restraining block coupled to the adapter and having a restraining wing formed to extend laterally so as to cover at least a portion of the first branch circuit breaker and the second branch circuit breaker.

7. The panel board of claim 6, wherein the branch busbar forms a fixing hole in an energized portion exposed to the open space, and
the adapter includes an adapter body having:
a fixing hook protruding to be inserted into the fixing hole; and
a fastening-member groove in which a fastening member is coupled.

8. The panel board of claim 7, wherein the adapter body further includes:
an insertion protrusion extending with a length toward the restraining block side.

9. The panel board of claim 7, wherein the adapter body further includes:
an insert tab inserted into and coupled to an insert groove of the adapter body, the insert tab having a through-hole forming the fastening-member groove.

10. The panel board of claim 6, wherein the restraining block includes:
a block body inserted into the open space and having a hollow fastening-member hole formed therein through which a fastening member passes;
a first restraining wing extending from one end of the block body to cover at least a portion of the first branch circuit breaker; and
a second restraining wing extending from the other end of the block body to cover at least a portion of the second branch circuit breaker.

11. The panel board of claim 10, wherein the block body further includes:
a position-fixing groove into which an insertion protrusion extending with a length from the adapter is inserted.
